(19) United States
(12) Patent Application Publication
(10) Pub. No.: US 2018/0158350 A1
(43) Pub. Date: Jun. 7, 2018

(54) SELF-READING BOOK AND STORY READER

(71) Applicant: DALAL HAMAD ALKHALID, KUWAIT (KW)

(72) Inventor: DALAL HAMAD ALKHALID, KUWAIT (KW)

(21) Appl. No.: 15/832,677

(22) Filed: Dec. 5, 2017

Related U.S. Application Data
(60) Provisional application No. 62/430,364, filed on Dec. 6, 2016.

(51) Int. Cl. G09B 5/06; G06F 17/30; G06F 3/0483; H04M 1/725

(52) U.S. Cl. CPC G09B 5/062; G06F 17/30026; H04M 1/72558; H04M 1/72527; G06F 3/0483

(57) ABSTRACT

The self-reading book and story maker allows the user to produce a battery-powered readable book having personal hand-produced script and/or graphics, as well as sound, such as music or voice, on each page. The book is intended to relay a personal story and will include a plurality of empty story pages attached to the book. Each page is connected to a number of electrical circuits, which are triggered by a number of sensors. Once a page has been filled with a producer's personal drawings or script, pre-recorded sounds (sound track) for the page will be transferred to the page using a special application for smart devices by USB, Bluetooth, WiFi or other available technologies. A microcontroller in concert with the sensors will work together to play a specific sound track for each respective page. Other system components can include a control panel, speakers, page-holders, and others.

### CROSS-REFERENCE TO RELATED APPLICATION

This application claims the benefit of U.S. Provisional Patent Application Ser. No. 62/430,364, filed Dec. 6, 2016.

### BACKGROUND

### 1. Field

The present invention relates generally to books, and particularly to a self-reading book and story maker that allows a user to mount drawings or photos to blank pages and then record a sound track telling an accompanying story for automatic playback.

### 2. Description of the Related Art

Electronic books (“ebooks”) have become increasingly popular in recent years. Ebooks now account for over 20% of all book sales in the United States, and that percentage is rising rapidly. Some estimates have the ebook market share reaching 50% as early as 2016. Electronic books can be displayed on dedicated electronic book reading devices, and electronic book reading applications are available for many electronic devices, such as smart phones and tablets, devices that many people already carry every day. With a single electronic device, a user can access millions of books, making the reading experience far more convenient and accessible.

However, for a variety of reasons, some people prefer traditional hard-copy books to their electronic counterparts. One such reason is the additional value that many people place on copies of books that include an autograph or other inscription made by the author.

Thus, a self-reading book and story maker solving the aforementioned problems is desired.

### SUMMARY

The self-reading book and story maker allows the user to produce a battery-powered readable book having personal hand-produced script and/or graphics, as well as sound, such as music or voice, on each page. The book is intended to relay a personal story and will include a plurality of empty story pages attached to the book. Each page is connected to a number of electrical circuits, which are triggered by a number of sensors. Once a page has been filled with a producer's personal drawings or script, pre-recorded sounds (sound track) for the page will be transferred to the page using a special application for smart devices by USB, Bluetooth, WiFi or other available technologies. A microcontroller in concert with the sensors will work together to play a specific sound track for each respective page. Other system components can include a control panel, speakers, page-holders, and others.

The self-readable book has many blank pages that the user can fill by drawing or writing or sketching by his pencil or stylus and record the story for his writing or the daily diary actions. Each page has an optical sensor connected to the control unit attached to the book. These and other features of the present invention will become readily apparent upon further review of the following specification and drawings.

### BRIEF DESCRIPTION OF THE DRAWINGS

FIG. 1 is a perspective view of an exemplary self-reading book and story maker.

FIG. 2 is a perspective view of a control panel for the self-reading book and story maker of FIG. 1, shown removed from the book.

FIG. 3 is a block diagram of selected electronic components of the self-reading book and story maker of FIG. 1.

FIG. 4A is a perspective view of a page of the self-reading book and story maker of FIG. 1, showing photo corners used as a page holder.

FIG. 4B is a perspective view of a page of the self-reading book and story maker of FIG. 1, showing a photo pocket used as a page holder.

FIG. 4C is a perspective view of a page of the self-reading book and story maker of FIG. 1, showing the rear side of a self-adhesive page used as a page holder.

FIG. 5 is a screen shot of an application for recording audio corresponding to a page in the self-reading book and story maker of FIG. 1 as displayed on a smart phone.

Similar reference characters denote corresponding features consistently throughout the attached drawings.

### DETAILED DESCRIPTION OF THE PREFERRED EMBODIMENTS

The self-reading book and story maker allows a user to produce a battery-powered readable book having personal hand-produced script and/or graphics, as well as sound, such as music or voice, on each page. The book is intended to relay a personal story and will include a plurality of empty story pages attached to the book. Each page is connected to a number of electrical circuits, which are triggered by a number of sensors. Once a page has been filled with a producer's personal drawings or script, pre-recorded sounds (sound track) for the page will be transferred to the page using a special application for smart devices by USB, Bluetooth, WiFi or other available technologies. A microcontroller in concert with the sensors will work together to play a specific sound track for each respective page. Other system components can include a control panel, speakers, page-holders, and others.

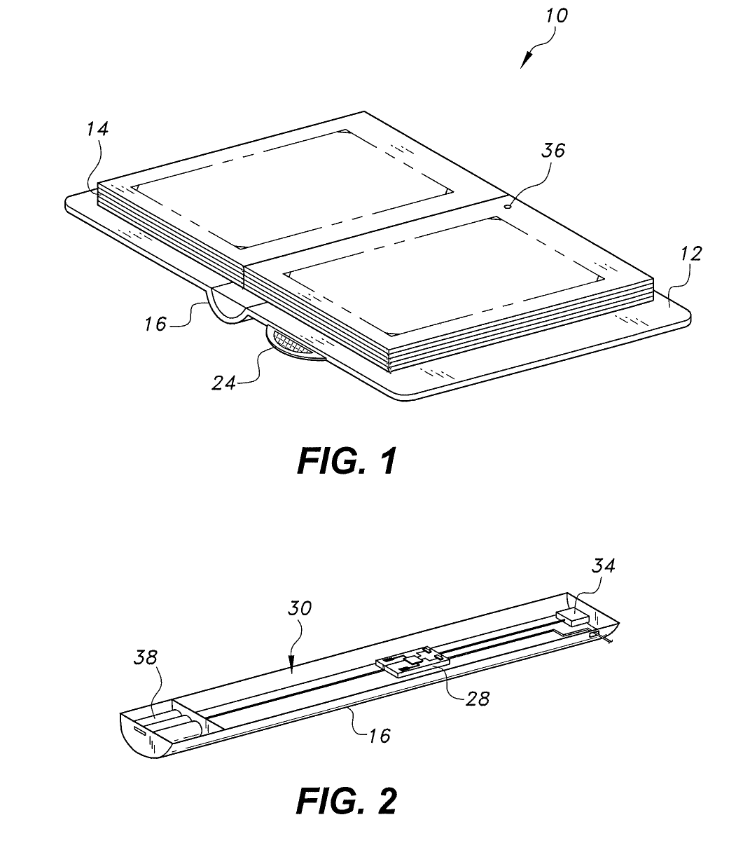

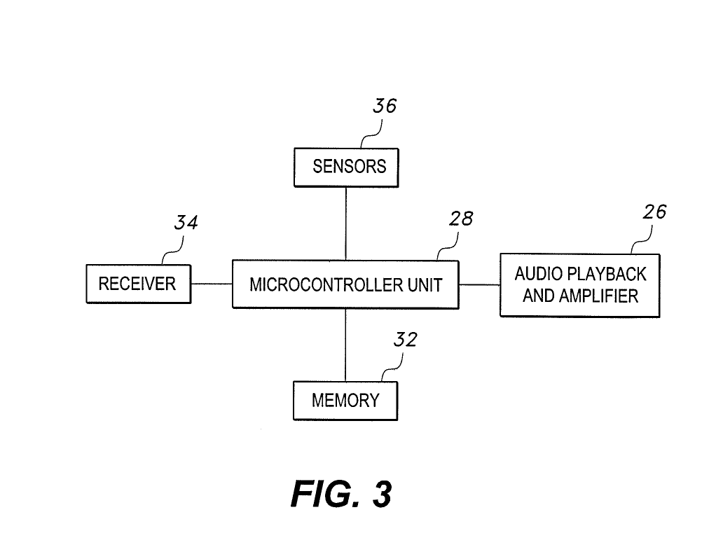

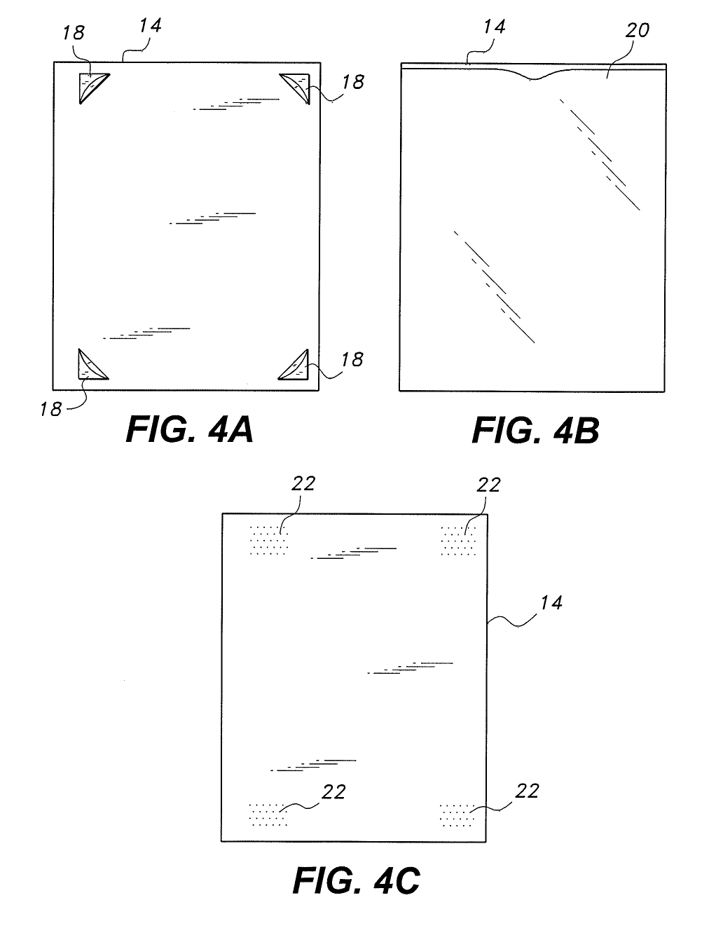

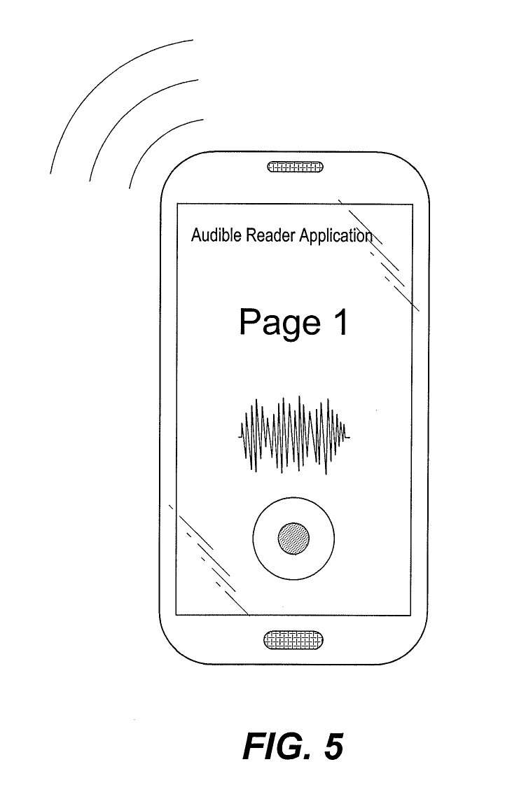

FIG. 1 is a diagrammatic perspective view of an exemplary self-reading book and story maker 10. The book comprises a cover 12 for covering and binding a multiplicity of blank or empty pages 14, which are bound to a book spine 16. Each page 14 is blank. The pages 14 may have a whiteboard (or blackboard) surface, as shown in FIG. 1, or any other surface that the user may draw or write on directly, or may have a page holder, such as photo mounting corners 18 (shown in FIG. 4A), a transparent photo pocket 20 (shown in FIG. 4B), or a self-adhesive backing 22 (shown in FIG. 4C) for mounting photos or drawings on the pages. The user fills the empty pages 14 using his pencil or stylus, or using the exemplary page holders 18, 20, or 22 attach his drawing or his history in the blank pages 14. Then the user may record music or any verbal narrative describing the story of the drawing or his diary by smart phone application (screen shot shown in FIG. 5) or by speaker/microphone 24 through an audio recording/playback unit 26 connected to a microcontroller unit 28 housed in a control panel or compartment 30 in the book's spine 16. The user records the voice and saves it in the memory 32 (shown in FIGS. 2 and 3) housed in the book's spine 16, or uploads the recorded digital voice file to the memory 32 from the smart phone by using USB, or wirelessly to the receiver 34 housed in the book spine 16, which may be by Bluetooth, a WiFi network card, or other available technologies.

Each page is connected to a number of electrical circuits housed in the control panel 30, which are triggered by sensors 36 attached to each page. The control panel 30 is connected to the page sensors 36, which are connected to the microcontroller 28. The circuit's components are powered by rechargeable batteries 38 housed in the book spine 16. The sensors 36 may be optical sensors, photocells, touch sensors, magnetic sensors, mechanical sensors, or any other sensors the serve the purpose of the device.

The user can script his diary and record each action so that it belongs to its own page 14. When the reader opens the book 10, he can see the diary page or the drawing and hear the recorded sound describing the story of the page 14, the microcontroller 28 retrieving the audio file for a particular page 14 from memory 32 and playing it back through the audio playback unit 26 and speaker 24 attached to the book cover 12.

It is to be understood that the self-reading book and story maker is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A self-reading book and story maker, comprising:
a book cover including a front cover, a rear cover, and a book spine disposed between the front cover and the rear cover, the book spine defining a compartment;
a plurality of empty story pages disposed between the front cover and the rear cover, the pages being adapted for inscription and drawing a story thereon by a user;
a control panel circuit disposed in the compartment defined by the book spine, the control panel circuit including a microcontroller, a memory connected to the microcontroller, and an audio playback unit connected to the memory and the microcontroller;
a plurality of sensors, each of the blank pages having a corresponding one of the sensors mounted thereon, the sensors being configured to send a signal uniquely identifying the page on which the sensor is mounted when the book is opened to that page;
a speaker mounted on the book cover, the speaker being connected to said audio playback unit;
a plurality of page-holders attached to at least some of the empty pages for attaching drawings, photos, or script relating to the story on at least some of the empty pages; and
means for permitting a user to record a digital audio file in the control panel memory containing music or verbal description corresponding to and accompanying each of the pages and connected with any script, drawings, and photos mounted or entered by the user, the microcontroller being configured to automatically actuate playback of the audio file corresponding to the page upon receiving a signal from the corresponding sensor that the book has been opened to that page.

2. The self-reading book and story maker according to claim 1, wherein said means for permitting a user to record a digital audio file comprises:
a receiver connected to said microcontroller and said memory; and
a smartphone application having means for recording the audio file and means for transmitting the file to the receiver.

3. The self-reading book and story maker according to claim 1, wherein said speaker comprises a speaker/microphone, whereby said means for permitting a user to record a digital audio file comprises the speaker/microphone.

4. The self-reading book and story maker according to claim 1, wherein at least some of said empty pages comprise whiteboard.

5. The self-reading book and story maker according to claim 1, wherein at least some of said empty pages comprise blackboard.

6. The self-reading book and story maker according to claim 1, wherein at least some of said page holders comprise adhesive photo corners.

7. The self-reading book and story maker according to claim 1, wherein at least some of said page holders comprise transparent photo pockets.

8. The self-reading book and story maker according to claim 1, wherein at least some of said page holders comprise self-adhesive pages.

9. The self-reading book and story maker according to claim 1, wherein said sensors comprise optical sensors.

10. The self-reading book and story maker according to claim 1, wherein said sensors are selected from the group consisting of photocell sensors, magnetic sensors, mechanical sensors and switches.

11. The self-reading book and story maker according to claim 1, further comprising an amplifier connected to said microcontroller.

12. The self-reading book and story maker according to claim 1, further comprising a battery power supply connected to said microcontroller.

13. A method for producing a self-reading book and story maker, comprising the steps of:
entering drawings, photos, or script onto blank pages in a book, the book having a microcontroller and each of the blank pages having a sensor mounted thereon configured for sending a signal to the microcontroller identifying the page when the book is opened to that page;
storing an audio file in memory housed in the book corresponding to each of the pages having drawings, photos, or script entered thereon, the audio file containing music or verbal description relating to the drawings, photos, or script; and
actuating the audio file to playback when the book is opened to the corresponding page, the actuating being performed automatically by the microcontroller in response to a signal from the sensor mounted on the corresponding page.

14. The method for producing a self-reading book and story maker according to claim 13, wherein said storing step comprises the step of narrating a story relating to the drawings, photos, or script into a microphone attached to the book and connected to the memory and the microcontroller.

15. The method for producing a self-reading book and story maker according to claim 13, wherein said storing step comprises the steps of creating the audio file on a smartphone and transmitting the audio file by wireless communication protocol to a receiver mounted in the book and connected to said memory.

16. The method for producing a self-reading book and story maker according to claim 13, wherein said entering step comprises the step of drawing directly on one of the blank pages.

17. The method for producing a self-reading book and story maker according to claim 13, wherein said entering step comprises the step of writing directly on one of the blank pages.

18. The method for producing a self-reading book and story maker according to claim 13, wherein said entering step comprises the step of mounting the drawings, photos, or script on one of the blank pages using adhesive photo mounting corners.

19. The method for producing a self-reading book and story maker according to claim 13, wherein said entering step comprises the step of mounting the drawings, photos, or script in a photo pocket on one of the blank pages.

20. The method for producing a self-reading book and story maker according to claim 13, wherein said entering step comprises the step of mounting the drawings, photos, or script on one of the blank pages using a self-adhesive backing.
